(19) United States
(12) Patent Application Publication
(10) Pub. No.: US 2022/0412663 A1
(43) Pub. Date: Dec. 29, 2022

(54) THERMAL GROUND PLANE

(71) Applicant: Reaction Engines Ltd, Abingdon, Oxfordshire (GB)

(72) Inventors: Yura Alexander SEVCENCO, Abingdon (GB); James Robert NYGAARD, Abingdon (GB)

(73) Assignee: Reaction Engines Ltd, Abingdon, Oxfordshire (GB)

(21) Appl. No.: 17/779,333

(22) PCT Filed: Nov. 18, 2020
(86) PCT No.: PCT/EP2020/082522

§ 371 Date: May 24, 2022

(30) Foreign Application Priority Data
Nov. 25, 2019 (GB) 1917135.4

(51) Int. Cl. F28D 15/02; F28D 15/04

(52) U.S. Cl. CPC F28D 15/0233; F28D 15/0241; F28D 15/0275; F28D 15/046; F28D 2020/0013

(57) ABSTRACT

A thermal ground plane comprises top and bottom layers that are substantially impervious to fluid and together defining an inner space, a vapour transport mesh layer having a relatively coarse mesh structure and located within said space, and at least one liquid transport mesh layer having a relatively fine mesh structure and located between said vapour transport mesh layer and one of said top and bottom layers, the two said mesh layers being in contact with one another across substantially their entire planar extents. The top and bottom layers are sealed with a substantially fluid tight seal, and said inner space contains a liquid and is partially evacuated.

### TECHNICAL FIELD

The present invention relates to heat pipes of the type know as Thermal Ground Planes.

### BACKGROUND

Heating and especially cooling of environments and components is commonly performed using active heat exchangers in which heat is transferred between two fluids. A classic example of a heat exchanger is found in an internal combustion engine in which a circulating fluid known as engine coolant flows through radiator coils and air flows past the coils, which cools the coolant and heats the incoming air.

To provide an alternative to such active heat exchangers, so-called “heat pipes” have been developed, the heat pipe being a heat-transfer device that combines the principles of both thermal conductivity and phase transition to effectively transfer heat between two solid interfaces, namely an evaporator and a condenser. The interior of the heat pipe is evacuated and the pipe sealed to maintain the vacuum. At the hot interface or evaporator of the heat pipe, a liquid in contact with a thermally conductive solid surface turns into a vapour by absorbing heat from that surface. The vapour then travels along the heat pipe to the cold interface or condenser and condenses back into a liquid—releasing the latent heat. The liquid then returns to the hot interface through either capillary action, centrifugal force, or gravity, and the cycle repeats.

Conventionally, heat pipes are indeed cylindrical pipes or pipes with other regular cross-section, with an evaporator region at one end of the heat pipe and a condenser region at the other end. A wicking structure extends along an inner surface of the pipe between the condenser region and the evaporator region in order to allow for the capillary flow. A heat pipe is much more efficient at transferring heat than an equivalent length of homogeneous thermally conductive material. Moreover, the heat pipe is essentially isothermal and does not rely on a thermal gradient between the evaporator and condenser regions. Heat pipes are commonly used on computer mother boards to provide cooling for the main CPU.

The Thermal Ground Plane (TGP) is a planar heat pipe that spreads the various thermal and flow processes across a planar structure. This allows one or more condenser and evaporator regions to be defined on one or both sides of the ground plane. By forming the TGP using flexible materials, a flexible TGP can be provided.

U.S. Pat. No. 9,163,883 describes a flexible TGP comprising upper and lower polymer layers on which are defined evaporator and condenser regions. A vapour core, i.e. a space, extends along the centre of the TGP and is bounded on each side by a mesh layer. Each mesh layer in turn defines a liquid channel between itself and the neighbouring polymer layer. Again, this liquid channel is a space. Wicking structures extend between the mesh layers and the evaporator and condenser regions. In the TGP of U.S. Pat. No. 9,163,883, liquid such as water is present in the liquid channel. The liquid enters the wicking structure at the evaporator region and evaporates, through the mesh layer and into the vapour core. The vapour then travels along the vapour core towards the condenser region, where it passes back through the mesh layer and into the associate wicking structure where it condenses back into liquid. The liquid flows back along the liquid channel by capillary action to the evaporator region and the process repeats. US20060124280 also describes a planar TGP as does the article titled “Flat flexible polymer heat pipes”, Christopher Osman et al, J. Micromech. Microeng. 23 (2013 015001).

Given the demanding heating and cooling requirements of rechargeable battery cells such as those used to power electric vehicles, it is not surprising that TGPs and in particular flexible TGPs have been proposed for use in this area. Flexible TGP are for example ideally suited for use with pouch and prismatic cells which themselves have a generally planar structure

As well as providing absolute heating and cooling for rechargeable battery cells, it has been recognised that flexible TGPs may provide a means for transferring heat from one internal region of a battery cell to another, or from an internal region to an external region. In the context of cylindrical battery cells for automotive uses, the article “A new approach to the internal thermal management of cylindrical battery cells for automotive applications”, Daniel Worwood et al, Journal of Power Sources 346 (2017) 151-16, considers internal cell thermal management including addressing the issue of temperature hotspots such as might arise close to the anode and cathode.

Whilst flexible TGP are well known, they have generally been intended (apart from a few isolated academic examples) for relatively high value use cases, such as the cooling of computer CPUs. If they are to find use in relatively low value use cases such as in the thermal management of electric vehicle batteries comprising many hundreds of cells, all of which may require individual cooling, flexible TGP manufacturing costs must be greatly reduced.

CN108448202 describes the use of heat pipes to cool an automobile battery.

### SUMMARY

According to a first aspect of the present invention there is provided a thermal ground plane comprising top and bottom layers that are substantially impervious to fluid and together defining an inner space, a vapour transport mesh layer having a relatively coarse mesh structure and located within said space, and at least one liquid transport mesh layer having a relatively fine mesh structure and located between said vapour transport mesh layer and one of said top and bottom layers, the two said mesh layers being in contact with one another across substantially their entire planar extents. The top and bottom layers are sealed with a substantially fluid tight seal, and said inner space contains a liquid and is partially evacuated.

The thermal ground plane may comprise at least one stiffening layer having a stiffness greater than those of said top and bottom layers and of said meshes, wherein the stiffening layer may be located between said liquid transport mesh layer and the top or bottom layer opposed to that mesh layer. The stiffening layer may contact the liquid transport mesh layer and the opposed top or bottom layer across substantially its entire planar extent. The stiffening layer may be a metal foil, for example steel foil, preferably having a thickness in the range 0.03 mm to 0.07 mm, more preferably 0.05 mm.

The thermal ground plane may comprise two liquid transport mesh layers located on opposed sides of said vapour transport mesh layer. It may also comprise a pair of said stiffening layers, each located between a liquid transport mesh layer and the top or bottom layer.

The vapour transport mesh may be a steel or nylon mesh, preferably having a mesh count in the range 10 to 20 per inch, more preferably 16 per inch. The liquid transport mesh may also be a steel or nylon mesh, preferably having a mesh count in the range 200 to 600 per inch, more preferably 400 per inch.

The vapour transport mesh layer may comprise a pair of vapour transport mesh sub-layers, wherein said vapour transport mesh sub-layers contact one another across substantially their entire planar extents and preferably have their weave directions misaligned, and comprising a layer of barrier material between said vapour transport mesh layer, such that the layer of barrier material provides a thermal barrier.

The thermal ground plane may comprise at least one layer of a phase change material, for example wax, that changes phase from a solid to a liquid with a thermal operating range of the thermal ground plane. The layer of phase change material may have distributed therein a material of relatively high thermal conductivity, for example graphite. The layer of phase change material may be located between said vapour transport mesh sub-layers.

According to a second aspect of the present invention there is provided a battery cell in combination with a thermal ground plane according to the above first aspect of the present invention.

According to a third aspect of the present invention there is provided a battery cell comprising a plurality of anode and cathode layers and, sandwiched between two of these layers, a thermal ground plane according to the above first aspect of the present invention. The thermal ground plane may be located entirely within an outer packaging of the battery cell. A resistive heating element may be attached to the thermal ground plane, with the resistive heating element being switchably coupled to the anode and cathode of the cell.

According to a fourth aspect of the present invention there is provided a thermal ground plane comprising top and bottom layers that are substantially impervious to fluid and being sealed together to define an inner space, the inner space containing a liquid and being partially evacuated, vapour and liquid transport channels within said space, and a phase change material within said space and that is solid at an ambient temperature and that melts at an elevated temperature within an operating range of the thermal ground plane. The phase change material may be wax. The phase change material may be provided as a layer of material sandwiched between two or more layers of a further material that is impervious to the phase change material and to said liquid and vapour.

According to a fifth aspect of the present invention there is provided electrically powered vehicle comprising one or more electric motors for providing motive power for the vehicle, and a battery unit for powering the electric motors, the battery unit comprising a multiplicity of battery cells and a multiplicity of thermal ground planes according to the above first or fourth aspects of the present invention for providing thermal management of the battery cells.

According to a further aspect of the invention there is provided a battery cell comprising a plurality of anode and cathode layers and a thermal ground plane located entirely within an outer packaging of the battery cell.

According to a still further aspect of the invention there is provided flexible thermal ground plane having selectively compressed regions to define preferential vapour flow paths. This thermal ground plane may have a structure according to one of the above aspects of the invention or one of the described preferred embodiments.

### BRIEF DESCRIPTION OF THE DRAWINGS

FIG. 1 is a cross-sectional view of a pouch cell incorporating a Thermal Ground Plane;

FIG. 2 is an exploded view of the Thermal Ground Plane of the pouch cell of FIG. 1;

FIG. 3 is an exploded view of an alternative Thermal Ground Plane incorporating a layer of phase change material;

FIG. 4 illustrates an electrically powered vehicle comprising a battery unit including thermal ground planes;

FIG. 5 illustrates schematically a plan view of a pouch cell battery in combination with a flexible thermal ground plane; and

FIG. 6 illustrates schematically a side cross-sectional view of the combination of FIG. 5.

### DETAILED DESCRIPTION

As well as providing for the absolute heating and cooling of battery cells such as are used in automotive applications, i.e. transferring heat between the cell and the external environment (be that within the vehicle or external to the vehicle), it is considered desirable to avoid excessive thermal gradients, e.g. hotspots, within the cells themselves. Such hotspots may occur for example in the vicinity of the cell terminal contacts or at interface layers, and if allowed to persist may result in issues such as a reduction in battery lifetime, fire risk, etc. A novel flexible or otherwise conformable Thermal Ground Plane (TGP) is proposed here that can be used to address this and other problems.

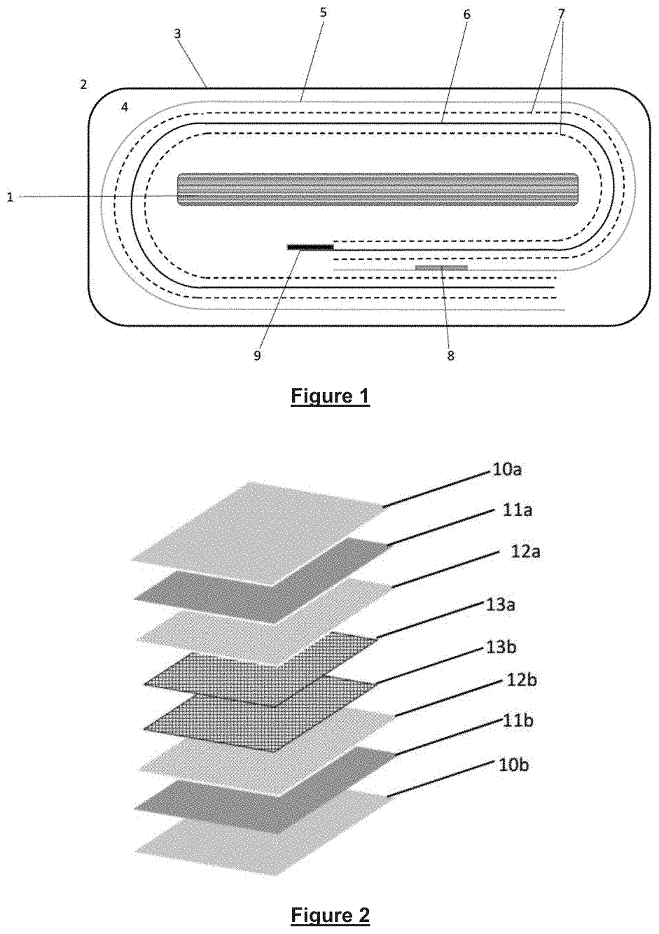

FIG. 1 shows by way of example a novel flexible TGP 1—described further below—incorporated into a battery pouch cell 2. The pouch cell 2 is of a generally conventional constructions apart from the incorporation of the TGP 1 and comprises an outer flexible package 3 containing a plurality of cell elements 4, each element comprising anode and cathode layers 5,6 and sandwiched between each of these a separator 7. Each of the anode and cathode layers are electrically coupled to anode and cathode tabs 8,9. These tabs are coupled to and electrically connected to plus and minus terminals (not shown) of the cell.

The flexible TGP 1 is located between the cell elements at the centre of the cell, although other locations may also be considered, e.g. between one of the outer cell elements and the package 3. Whilst use of only a single TGP 1 is described here, a cell might contain multiple TGPs (which are thermally independent of one another or which are in some way thermally connected other than through the cell elements).

The flexible TGP 1 is located within the pouch cell such that, when the package around the cell is sealed, the TGP is completely enclosed by the package. In this embodiment there is no thermal connection between the TGP and the exterior of the cell, other than via the other internal components of the cell and the package. Again, other configurations are possible.

For example, the TGP 1 may extend out through a slot in the cell package (ensuing a seal between the interior and exterior of the cell), or a thermally conductive tab may be attached to the TGP with the tab extending out through slot in the package.

FIG. 2 shows an exploded view of the TGP from which it can be seen that the TGP comprises eight discrete layers packed together to form a relatively thin and flexible planar structure. In order to allow the TGP to be easily accommodated within an otherwise conventional pouch cell, a total TGP thickness in the region of 1 mm may be desirable.

The outer layers of the TGP are of aluminium foil PET laminate 10a,10b (i.e. a PET-aluminium-PET sandwich). As will be described further below, these outer layers can be heat sealed along their edges to form a pouch within which the other layers are wholly contained. On the inside of the layers 10a,10b there are provided respective stainless steel foil layers 11a,11b, each 0.05 mm thick. Inside of these layers there are provided four steel mesh layers 12a,12b and 13a,13b. The properties and functions of the various layers contained within the pouch are as follows:

### Fine Mesh 12a,12b

As already discussed above, a TGP uses capillary action which exploits surface energy forces to transport liquids through pores or across surfaces. This behaviour can be manipulated by controlling the pore size or altering the surface energy itself through plasma cleaning or removal of surface oxides. An array of fine stainless steel fibres woven into a mesh can make an effective wicking material for the transport of liquid water. A suitable pore spacing between wires has been found to be 400 wires per inch with a wire diameter of approximately 0.03 mm. Water vapour can condense on the inner sides of the top and bottom laminate layers 10,10b so a pair of these fine meshes is needed inside each cooling foil to provide internal wicking on both walls of the vapour chamber. In other words, the fine meshes provide liquid wicking channels on both sides of the TGP inner structure.

### Coarse Mesh 13a,13b

In order to provide an open volume into which the boiling water vapour can expand, a structural support material must also be included to hold open the pouch and maintain the overall shape whilst at the same time not obstructing the gas movement. A larger or coarse wire mesh with wide open area between the weave is appropriate for this support material: a suitable stainless steel gauze with 16 wires per inch, with a wire diameter of approximately 0.24 mm, has been found to be suitable. A pair of these coarse meshes is combined to create a sufficiently large open volume on the inside of the vapour chamber. Together, the two coarse meshes form the inner vapour chamber of the TGP structure.

Whilst the vapour chamber may be formed from a single (e.g. thicker) 16 mesh, it can be advantageous to use two adjacent 16 meshes or “sub-meshes” as illustrated in the Figure as this results in a discontinuity in the mesh structure at the interface between the two 16 meshes. Advantageous results may be achieved by deliberately misaligning the mesh weave directions.

### Stainless Steel Foil

The requirement to evacuate the pouches and hold them at a low vacuum pressure for stable operation at temperatures near 40° C. necessitates a rigid structural component in the pouches to prevent them from collapsing in on themselves. Without such a support structure the malleable plastic pouch material (outer layers of aluminium foil PET laminate) will conform to the contours of the wire meshes it contains. The necessary structure is provided by a pair of rigid stainless steel foils 11a,11b located on the inside of both of the pouch outer walls to hold the pouch open and ensure enough internal volume for the boiled water to migrate unobstructed through the vapour chamber. A steel foil thickness of 0.05 mm is considered appropriate. The main constraint on this parameter is the preferable 1 mm overall thickness of the assembled TGP as well as the need to maintain a sufficient degree of flexibility in the overall TGP package.

It will be appreciated that the various layers are easily cut to size and assembled to form the TGP package. The package may be sealed along three sides by heat sealing opposing surfaces of the outer laminate layers, allowing the use of an automated injector syringe to inject a fixed volume of water, e.g. 2 ml of degassed and demineralized water, into the open end of the pouch immediately before vacuum sealing (to a pressure of approximately 50 mbar) using an automated sealing machine (i.e. closing the remaining open end of the pouch). NB. The filling with water is not selectively aimed at any particular layer of the inner structure of the TGP as once filled the liquid water will migrate to the fine mesh wicking structure.

In one embodiment, appropriate for the 2 ml water fill, each component layer is cut to the same approximate final dimensions of 121 mm by 115 mm in order to correctly align and fit inside the laminate pouches (pre-cut to provide 5 mm boundary). It is important that the internal mesh components are fully covered by the stainless steel foil stiffeners, so these can be cut marginally larger than the undersized mesh to ensure full coverage. The reasons for this are, firstly, that the steel foil stiffeners are designed to maintain the vapour chamber volume by holding open the packaging during evacuation and, secondly, that the exposed sections of mesh can otherwise puncture the outer laminate packaging.

Although not shown in the drawings, either for testing or control purposes, it is possible to incorporate thermocouples to the outer surface of the TGP pouch at one or more locations. Ideally these should not protrude excessively from the pouch surface in order to keep the overall thickness to a minimum.

The TGP described above is able to transfer heat efficiently between two or more surface regions of the outer laminate layers. However, these are not necessarily predefined surface regions and as such the TGP reacts to cool hotspots (or heat cool spots) wherever these occur. The active temperature range over which the TGP operates is dictated by the working fluid as it undergoes a phase transformation (liquid to vapour and vapour to liquid). This range can be adjusted by adjusting the internal pressure of the TGP. In this way the TGP has the potential to provide a passive thermal management solution across a wide range of different applications.

Those of skill in the art will appreciate that various modifications may be made to the above described embodiment without departing from the scope of the invention. In particular, the following modifications may be considered.

### Hermetically Sealed Container

Rather than using an aluminium foil PET laminate pouch, the sealed container may be manufactured using extruded copper or aluminium, seam welded stainless steel foils or different combinations of metallized polymers and plastic-foil laminates.

### Working Fluid

Alternatives to degassed and demineralized water include ammonia, methanol, dichloromethane, ethylene glycol, R123, XP30 and glycerol.

### Wicking Material

Alternative forms of wicking material include textiles, porous polymer sponge, sintered copper, etched microchannels or any hydrophilic treated surface.

### Structural Vapour Channels

Alternative structural supports to increase the vapour chamber volume include microtubes, polymer mesh, synthetic netting, and 3D printed plastic meshing.

### Stiffening Support

Alternative structural stiffeners include foils manufactured from different metallic alloys, thicker Perspex, glass, ceramics or use of a more rigid pouch material, negating the need for separate stiffeners.

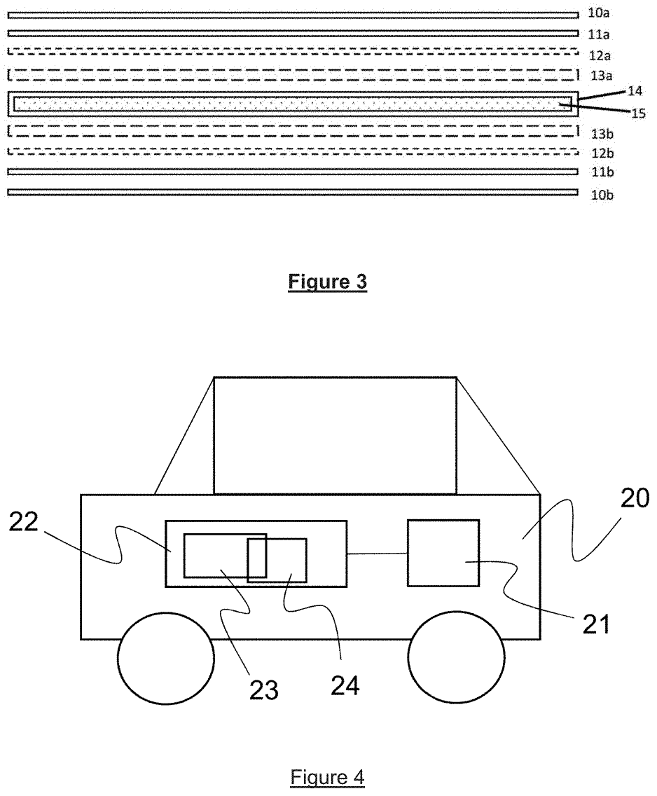

In order to provide a heat sink within the TGP, a layer of a further phase change material may be incorporated into the TGP pouch. FIG. 3 illustrates such a configuration having a structure similar to the described with reference to FIG. 2 (where the same reference numerals are used to identify similar layers), but with a layer of wax 15 inserted between the two coarse mesh layers. The wax layer 15 is separated from the coarse mesh layers by, in this example, respective aluminium foil PET layers 14, sealed around their edges, in order to prevent the wax from flowing into the coarse mesh layers. In order to increase the thermal conductivity of the wax, graphite particles are incorporated into the wax.

In operation, when a surface region of the TGP pouch begins to heat up relative to other surface regions, heat will be conducted through the various layers of the pouch to the wax. The wax close to the heated region will absorb a limited amount of heat energy. At a temperature below that which will vaporize the water, the heated region of the wax will begin to melt, greatly increasing its ability to absorb heat energy as it does so. As melting spreads across the wax layer, heat energy will also spread. Once the entire wax layer has melted, the wax layer's ability to absorb heat energy will fall. Assuming that the hotspot continues to heat up, at some later time the water will then begin to vapourise. Of course the melting point of the wax and the vaporization point of the water can be controlled (e.g. to overlap). An additional benefit of the wax layer is that it will have the effect of blocking transfer of heat through the TGP from one side to the other which may be advantageous in some circumstances.

Whilst the flexible TGP described above is considered well suited to providing a means for evenly distributing heat within a battery cell, it may also be used as a means for heating and cooling the cell in absolute terms. If the TGP is located within the cell, a tab may project from the TGP, out of the cell, for thermal coupling to some heat exchange system. The TGP may be located wholly outside of the cell but in thermal contact with an exterior surface of the cell. The flexible TGP may find uses outside of automotive applications, for example in aeronautical and space applications, whether these relate to battery cells or not.

FIG. 4 illustrates schematically an electrically powered vehicle 20, comprising an electrical motor 21 providing motive power for the vehicle. The vehicle comprises a battery unit 22 that comprises a multiplicity of battery cells 23. The unit further comprises a multiplicity of TGPs 24 according to one of the designs described above. The TGPs may be encapsulated within the individual battery cells or may be outside of the cells (or may be both inside and outside of the cells).

It will be appreciated by the person of skill in the art that various modifications may be made to the above described embodiments without departing from the scope of the present invention.

One modification, vis-à-vis the structure of FIG. 2, involves the insertion of a barrier between the two (vapour) mesh layers. This has the effect of partial thermal isolation of one side of the TGP from the other by preventing vapour transmission transversely through the plane. Thus heat transmission would be limited to that in the plane, and heat ejection would occur on the same surface as it was applied. This could be advantageous in a battery cooling application where it is important to limit the potential for an overheating cell (catastrophic failure) to damage its neighbouring cell(s) by transmitting that heat to its neighbours. Each face of the modified TGP would act as an independent heat-spreading and cooling means for the cell surface to which it is attached.

It is also possible to entirely separate the vapour core of each heat spreader (of each side of the TGP) by using an oversized barrier which is embedded in the polymer casing surrounding the TGP, when sealed at the edges. Alternatively the barrier could have the same dimensions as the other layers and have some vapour/liquid communication between each side at the edges of the barrier. In the separated case, a vacuum would have to be separately applied to each side of the TGP. The barrier material may be any material that is impervious to the liquid or vapour of the working fluid. It may be advantageous to form the barrier of a low thermal conductivity material to prevent heat conduction to the other side of the TGP, e.g. a suitable polymer could be used.

Thermal management of the cell in terms of its warming, when below ideal operating temperature could be achieved by attaching a resistive heater e.g. composed of electrically conducting polymer to the thermal ground plane. Thus a current, either from the cell itself, or from an external source, could be switched to flow through the resistive heater and the heat would be spread through the cell by the TGP. A remotely operated switch could be built into the cell such that a current could be drawn through the heater plate when activated by an external field e.g. magnetic or electromagnetic.

In a further modification to the flexible TGP constructions described above, it may be desirable to create depressions in the generally planar structure by stamping or otherwise forming a pattern into the TGP. In this way a heat flow “circuit” can be formed to create preferential heat flow paths, for example to provide certain areas of known higher energy flux with a faster path to dissipate heat.

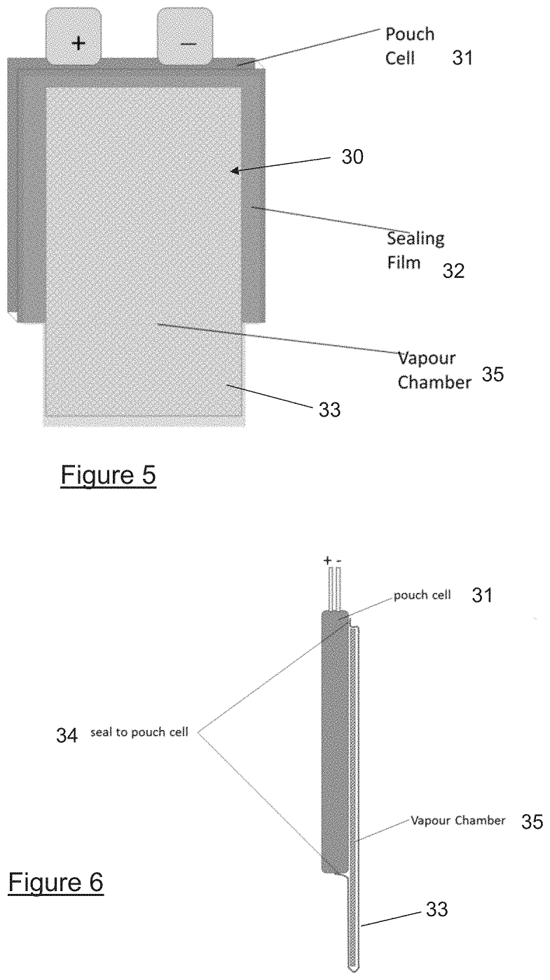

In the context of battery cooling, an advantageous construction is illustrated in the plan view of FIG. 5 and side cross-sectional view of FIG. 6. This construction envisages the building of a TGP 30 (e.g. a planar vapour chamber) including vapour chamber 35 onto the exterior of a pouch cell 31, such that the exterior of the cell 32 (for example a polymer film) constitutes part of one of the walls of the TGP. The TGP 30 may extend from the cell such that the extended part 33 engages with a heat exchanger (not shown), or other means of conducting heat away from the TGP. In order to charge the TGP 30 with working fluid, and to evacuate it to the desired pressure, a sealable port (not shown) is used to inject working fluid (e.g. water) and subsequently to apply vacuum before a permanent seal 34 is formed.

1. A thermal ground plane comprising:
top and bottom layers that are substantially impervious to fluid and together defining an inner space;
a vapour transport mesh layer having a relatively coarse mesh structure and located within said space; and
at least one liquid transport mesh layer having a relatively fine mesh structure and located between said vapour transport mesh layer and one of said top and bottom layers, the two said mesh layers being in contact with one another across substantially their entire planar extents,
wherein the top and bottom layers are sealed with a substantially fluid tight seal, and said inner space contains a liquid and is partially evacuated.

2. A thermal ground plane according to claim 1 and comprising at least one stiffening layer having a stiffness greater than those of said top and bottom layers and of said meshes.

3. A thermal ground plane according to claim 2, wherein said stiffening layer is located between said liquid transport mesh layer and the top or bottom layer opposed to that mesh layer.

4. A thermal ground plane according to claim 3, wherein said stiffening layer contacts the liquid transport mesh layer and the opposed top or bottom layer across substantially its entire planar extent.

5. A thermal ground plane according to claim 2, the stiffening layer being a metal foil, for example a steel foil, optionally having a thickness in the range 0.03 mm to 0.07 mm, optionally 0.05 mm.

6. A thermal ground plane according to claim 1 and comprising two liquid transport mesh layers located on opposed sides of said vapour transport mesh layer.

7. A thermal ground plane according to claim 1 and comprising:
at least one stiffening layer having a stiffness greater than those of said top and bottom layers and of said meshes;
two liquid transport mesh layers located on opposed sides of said vapour transport mesh layer; and
a pair of said stiffening layers, each located between a liquid transport mesh layer and the top or bottom layer.

8. A thermal ground plane according to claim 1, wherein the vapour transport mesh is a steel or nylon mesh.

9. A thermal ground plane according to claim 1, wherein the vapour transport mesh has a mesh count in the range 10 to 20 per inch (0.39 to 0.79 per mm).

10. A thermal ground plane according to claim 1, wherein the liquid transport mesh is a steel or nylon mesh.

11. A thermal ground plane according to claim 1, the liquid transport mesh having a mesh count in the range 200 to 600 per inch (7.87 to 23.6 per mm).

12. A thermal ground plane according to claim 1, wherein said vapour transport mesh layer comprises a pair of vapour transport mesh sub-layers.

13. A thermal ground plane according to claim 12, wherein said vapour transport mesh sub-layers contact one another across substantially their entire planar extents and have their weave directions misaligned.

14. A thermal ground plane according to claim 12 and comprising a layer of barrier material between said vapour transport mesh sub-layers.

15. A thermal ground plane according to claim 14, wherein said layer of barrier material provides a thermal barrier.

16. A thermal ground plane according to claim 1, wherein said liquid is degassed and demineralized water.

17. A thermal ground plane according to claim 1, wherein said top and bottom layers are of an aluminium PET laminate.

18. A thermal ground plane according to claim 17, wherein said top and bottom layers are sealed around their edges using, for example, heat sealing.

19. A thermal ground plane according to claim 1 and comprising at least one layer of a phase change material, for example wax, that changes phase from a solid to a liquid with a thermal operating range of the thermal ground plane.

20. A thermal ground plane according to claim 19, where said layer of phase change material has distributed therein a material of relatively high thermal conductivity.

21. A thermal ground plane according to claim 20, wherein said material of relatively high thermal conductivity is graphite.

22. A thermal ground plane according to claim 20, wherein said vapour transport mesh layer comprises a pair of vapour transport mesh sub-layers said layer of phase change material is located between said vapour transport mesh sub-layers.

23. A thermal ground plane according to claim 19, said phase change material being provided as a layer of material sandwiched between two or more layers of a further material that is impervious to the phase change material and to said liquid and vapour.

24.-37. (canceled)
